(19) United States
(12) Patent Application Publication
(10) Pub. No.: US 2024/0375986 A1
(43) Pub. Date: Nov. 14, 2024

(54) METHOD FOR CONDITIONING ADVANCED ANAEROBIC DIGESTION SLUDGE BY DEEP DEHYDRATION BASED ON PARTICLE SIZE CONTROL, USE THEREOF AND FLOC PARTICLE

(71) Applicant: BEIJING DRAINAGE GROUP CO., LTD, Beijing (CN)

(72) Inventors: Xingmin FU, Beijing (CN); Jiawei WANG, Beijing (CN); Wei WANG, Beijing (CN); Yawei ZHAO, Beijing (CN); Yang WEN, Beijing (CN); Jilu SUN, Beijing (CN); Yao LlU, Beijing (CN); Jun HAN, Beijing (CN)

(21) Appl. No.: 18/686,952

(22) PCT Filed: Jun. 24, 2022
(86) PCT No.: PCT/CN2022/101092

§ 371 Date: Feb. 27, 2024

(30) Foreign Application Priority Data
Dec. 22, 2021 (CN) 212111581810.7

(51) Int. Cl. C02F 9/00; C02F 11/122; C02F 11/143; C02F 11/147

(52) U.S. Cl. CPC C02F 9/00; C02F 11/122; C02F 11/143; C02F 11/147

(57) ABSTRACT

A method for conditioning advanced anaerobic digestion sludge by deep dehydration based on particle size control, the use thereof and a floc particle. The method for conditioning advanced anaerobic digestion sludge by deep dehydration comprises: (1) uniformly mixing advanced anaerobic digestion sludge with a first cationic organic flocculant to obtain non-hard muddy flocculated particles; (2) uniformly mixing the muddy flocculated particles with aggregate; (3) uniformly mixing the resulting mixture with inorganic agent; (4) adjusting the particle size of the floc particles using second organic flocculant; and (5) performing plate-frame dehydration so as to reduce the moisture content to 60% or less. In the method, by means of the combination of organic flocculation nucleation with a particle size skeleton, the use amount of the inorganic agent is effectively reduced, such that the conductivity of the mud cake is reduced, facilitating the landscaping utilization, incineration disposal etc., of the dehydrated mud cake.

### FIELD OF TECHNOLOGY

The present disclosure belongs to the field of sludge treatment and disposal, more specifically, relates to a method for conditioning advanced anaerobic digestion sludge by deep dehydration based on particle size control, the use thereof and a floc particle.

### BACKGROUND

Sludge treatment and disposal technology both adhere to the principles of “reduction, harmlessness, stabilization and resource utilization”, among which reduction is the chief problem to be solved in sludge treatment.

At present, deep dehydration of sludge is the most direct measure to solve the problem of sludge reduction. Plate and frame filter press dehydration is one of the commonly used mechanical dehydration methods.

Advanced anaerobic digestion sludge refers to the use of sludge that undergoes high-temperature and high-pressure hydrothermal treatment and anaerobic digestion treatment to recover the remaining residue of biogas.

Existing test results show that after thermal hydrolysis treatment of sludge, the particle size of floc is greatly reduced, the median particle size is reduced to about 14 μm, the floc specific surface area reaches 2200˜2400 cm²/g, and the sludge floc has strong capillary suction capacity and is difficult to be dehydrated.

At present, dehydration of advanced anaerobic digestion sludge generally uses a great amount of inorganic conditioning agent and organic flocculant for compound conditioning. The conditioning methods used generally pursue the maximum reaction between conditioning agent and flocs to change physical and chemical properties of extracellular polymers, and even break the cell wall to complete the final conditioning. This kind of traditional method generally has the disadvantages of a large dosage of conditioning agent (such as the various inorganic conditioning agents and their dosages recorded in “Optimization Research on Advanced Anaerobic Digestion Sludge Conditioning Technology by Deep Dehydration”), high dehydration cost, and high EC value of sludge cake, which is not conducive to the final disposal of the sludge cake.

### SUMMARY

The purpose of the present disclosure is to propose a method for conditioning advanced anaerobic digestion sludge by deep dehydration based on particle size control in view of the technical problems of small particle size of floc of advanced anaerobic digestion sludge and large usage of inorganic conditioning agent.

In order to achieve the above objectives, the first aspect of the present disclosure provides a method for conditioning advanced anaerobic digestion sludge by deep dehydration based on particle size control, wherein the method for conditioning advanced anaerobic digestion sludge by deep dehydration comprising:
(1) uniformly mixing the advanced anaerobic digestion sludge with first cationic organic flocculant to obtain non-hard muddy flocculated particles;
wherein addition amount of the first cationic organic flocculant is 1.5 wt % c to 3.0 wt % of dry solid amount of the advanced anaerobic digestion sludge;
(2) uniformly mixing the muddy flocculated particles obtained in step (1) with aggregate;
wherein addition amount of the aggregate is 3 wt % to 10 wt % of the dry solid amount of the advanced anaerobic digestion sludge;
(3) uniformly mixing mixture obtained in step (2) with inorganic agent to improve a particle surface hydrophobicity;
wherein addition amount of the inorganic agent is 0.5 wt % to 3.5 wt % of the dry solid amount of the advanced anaerobic digestion sludge;
(4) adjusting a particle size of floc particles obtained in step (3) using second cationic organic flocculant, so that the floc particles meet the following requirements: D10: 70-150 μm, D50: 200-400 μm, D90: >500 μm;
(5) performing plate and frame dehydration on substance obtained in step (4) to reduce moisture content of the sludge to 60% or less.

According to the present disclosure, in step (1), the non-hard muddy flocculated particle obtained is a non-hard muddy core with a certain size; in step (2), the aggregate provides a skeleton forming a drainage channel, which plays the role of guiding water; in step (3), the mixture obtained in step (2) is uniformly mixed with the inorganic agent to form large-size floc particles with aggregate as the skeleton; in step (4), it has been verified by the inventor's long-term practical operation that the floc particles meet: D10: 70-150 μm, D50: 200-400 μm, D90: >500 μm, which is most conducive to the next step of dehydration, making the moisture content of sludge easily dropped to 60% or less.

As a preferred embodiment, the first cationic organic flocculant is at least one of PAM, tannic acid and polydiallyldimethylammonium chloride, and the second cationic organic flocculant is PAM. Most preferably, the first cationic organic flocculant and the second cationic organic flocculant are both PAM.

As a preferred embodiment, in step (2), the aggregate is selected from at least one of sludge carbon, activated carbon, flyash, and highly dry sludge particles.

As a preferred embodiment, in step (2), a particle size of the aggregate is less than or equal to 0.3 mm.

As a preferred embodiment, in step (3), the inorganic agent is selected from at least one of polyaluminum sulfate, polyaluminum chloride, polyferric sulfate, aluminum chloride, aluminum sulfate and ferric chloride.

As a preferred embodiment, in step (4), addition amount of the second cationic organic flocculant is 1.5 wt % to 3.0 wt % of the dry solid amount of sludge.

A second aspect of the present disclosure provides a floc particle obtained by the above method for conditioning advanced anaerobic digestion sludge by deep dehydration based on particle size control.

The third aspect of the present disclosure provides use of the above method for conditioning advanced anaerobic digestion sludge by deep dehydration based on particle size control in sludge treatment and disposal.

Beneficial effects of the present disclosure include: the present disclosure starts from controlling the particle size of sludge flocs and adopts the method of organic flocculation nucleation combined with particle size skeleton, which can effectively reduce the usage of inorganic agent and thereby reduce the conductivity of mud cake, which is beneficial to landscaping utilization, incineration disposal, etc. of dehydrated cakes. In addition, through the improvement of the conditioning method, the method can be completed using commonly used chemicals on the market, eliminating the technical barriers to conditioning and dehydration of advanced anaerobic digestion sludge, and greatly reducing the cost of conditioning and dehydration of advanced anaerobic digestion sludge.

Other features and advantages of the present disclosure will be described in detail in the following detailed description.

### BRIEF DESCRIPTION OF THE DRAWINGS

FIG. 1 shows a photo of the mud cake obtained in embodiment 1 of the present disclosure;

FIG. 2 shows a photo of the mud cake obtained in embodiment 2 of the present disclosure;

FIG. 3 shows a photo of the mud cake obtained in embodiment 3 of the present disclosure.

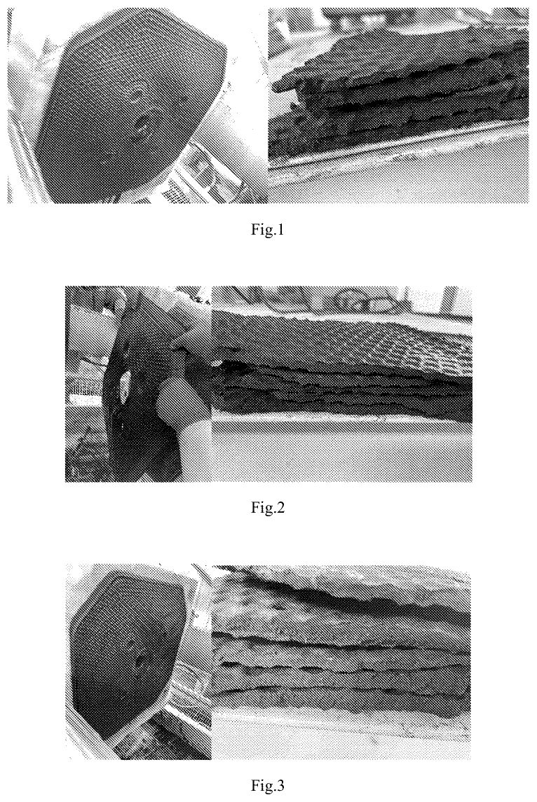

### DESCRIPTION OF THE EMBODIMENTS

Preferred embodiments of the invention will be described in more detail below. Although preferred embodiments of the present invention are described below, it should be understood that the present invention may be implemented in various forms and should not be limited to the embodiments set forth herein. Rather, these embodiments are provided so that this disclosure will be thorough and complete, and will fully convey the scope of the invention to those skilled in the art.

In the embodiments of the present disclosure, the source of sludge carbon is the solid phase product obtained by drying the advanced anaerobic digestion sludge and carbonizing it at 750° C. for 30 minutes.

In the embodiments of the present disclosure, the dosage is relative to the dry solid amount of advanced anaerobic digestion sludge. Wherein the qualified standard for moisture content of the filter cake is ≤60%.

### Embodiment 1

This embodiment provides a method for conditioning advanced anaerobic digestion sludge by deep dehydration based on particle size control.

Sludge quality of the advanced anaerobic digestion sludge:
After the primary sedimentation and residual sludge undergoes thermal hydrolysis reaction at 165° C. for 30 minutes, it undergoes medium-temperature anaerobic digestion (40±2° C.), and the solid content of the sludge is 6.40 wt %, the floc particle sizes D10, D50, and D90 of the sludge are respectively: 4.6 μm, 14.1 μm, and 67.0 μm, and the capillary suction time (CST) is: 732.1 s.

### Sludge Conditioning:

(1) Use cationic PAM as the initial coagulation core of the flocculant with the dosage of 0.25 wt %, and control the stirring frequency to 18 Hz and the stirring time to 5 min to form preliminary floc particles. The floc particle sizes D10, D50, and D90 are respectively: 30.0 μm, 146.2 μm, and 380.9 μm; the capillary suction time (CST) is: 399.1 s.
(2) Use sludge carbon as the supporting framework of floc particles with the dosage of 5 wt % and particle size of ≤250 μm, and control the stirring frequency to 18 Hz and the stirring time to 5 min. The floc particle sizes D10, D50 and D90 are respectively: 34.8 μm, 163.2 μm, and 399.8 μm; the capillary suction time (CST) is: 403.3 s.
(3) Use polymerized aluminum sulfate as a surface modifier to improve surface hydrophobicity with the dosage of 2 wt %, and control the stirring frequency to 20 Hz and the stirring time to 15 min. The floc particle sizes D10, D50, D90 are respectively: 37.9 μm, 241.6 μm, and 672.6 μm; the capillary suction time (CST) is: 253.4 s.
(4) Use cationic PAM as the flocculant for final flocculation with the dosage of 0.15 wt %, and control the stirring frequency to 13.5 Hz and the stirring time to 5 min to form final floc particles. The floc particle sizes D10, D50, and D90 are respectively: 108.8 μm, 344.9 μm, and 799.5 μm; the capillary suction time (CST) is: 28.0 s.
(5) Pressing and dehydration: use a membrane filter press for mechanical dehydration. The size of the filter plate is 80 cm×80 cm, the pressing pressure is 1.0˜1.6 MPa, the pressing time is 90 min; and the moisture content of the finally obtained filter cake is 56.57%.

### Embodiment 2

This embodiment provides a method for conditioning advanced anaerobic digestion sludge by deep dehydration based on particle size control.

Sludge quality of the advanced anaerobic digestion sludge:

After the primary sedimentation and residual sludge undergoes thermal hydrolysis reaction at 165° C. for 30 minutes, it undergoes medium-temperature anaerobic digestion (40±2° C.), and the solid content of the sludge is 5.59 wt %, the floc particle sizes D10, D50, and D90 of the sludge are respectively: 5.8 μm, 18.1 μm, and 117.5 μm, and the capillary suction time (CST) is: 455.2 s.

### Sludge Conditioning:

(1) Use cationic PAM as the initial coagulation core of the flocculant with the dosage of 0.25 wt %, and control the stirring frequency to 18 Hz and the stirring time to 5 min to form preliminary floc particles. The floc particle sizes D10, D50, and D90 are respectively: 43.7 μm, 155.7 μm, and 377.5 μm; the capillary suction time (CST) is: 231.6 s.
(2) Use sludge carbon as the supporting framework of floc particles with the dosage of 5 wt % and particle size of ≤250 μm, and control the stirring frequency to 18 Hz and the stirring time to 5 min. The floc particle sizes D10, D50 and D90 are respectively: 41.9 μm, 159.8 μm, and 402.5 μm; the capillary suction time (CST) is: 229.7 s.
(3) Use polymerized aluminum sulfate as a surface modifier to improve surface hydrophobicity with the dosage of 1 wt %, and control the stirring frequency to 20 Hz and the stirring time to 15 min. The floc particle sizes D10, D50, D90 are respectively: 45.5 μm, 190.0 μm, and 505.6 μm; the capillary suction time (CST) is: 151.9 s.
(4) Use cationic PAM as the flocculant for final flocculation with the dosage of 0.15 wt %, and control the stirring frequency to 13.5 Hz and the stirring time to 5 min to form final floc particles. The floc particle sizes D10, D50, and D90 are respectively: 73.8 μm, 220.2 μm, and 524.8 μm; the capillary suction time (CST) is: 59.5 s.
(5) Pressing and dehydration: use a membrane filter press for mechanical dehydration. The size of the filter plate is 80 cm×80 cm, the pressing pressure is 1.0˜1.6 MPa, the pressing time is 90 min; and the moisture content of the finally obtained filter cake is 51.68%.

### Embodiment 3

This embodiment provides a method for conditioning advanced anaerobic digestion sludge by deep dehydration based on particle size control.

Sludge quality of the advanced anaerobic digestion sludge:

After the primary sedimentation and residual sludge undergoes thermal hydrolysis reaction at 165° C. for 30 minutes, it undergoes medium-temperature anaerobic digestion (40±2° C.), and the solid content of the sludge is 6.67 wt %, the floc particle sizes D10, D50, and D90 of the sludge are respectively: 4.6 μm, 14.2 μm, and 72.7 μm, and the capillary suction time (CST) is: 1261.1 s.

### Sludge Conditioning:

(1) Use cationic PAM as the initial coagulation core of the flocculant with the dosage of 0.25 wt %, and control the stirring frequency to 18 Hz and the stirring time to 5 min to form preliminary floc particles. The floc particle sizes D10, D50, and D90 are respectively: 13.1 μm, 57.9 μm, and 197.5 μm; the capillary suction time (CST) is: 621 s.
(2) Use sludge carbon as the supporting framework of floc particles with the dosage of 5 wt % and particle size of ≤250 μm, and control the stirring frequency to 18 Hz and the stirring time to 5 min. The floc particle sizes D10, D50 and D90 are respectively: 20.0 μm, 105.5 μm, and 275.7 μm; the capillary suction time (CST) is: 572.5 s.
(3) Use polymerized aluminum sulfate as a surface modifier to improve surface hydrophobicity with the dosage of 2.0 wt %, and control the stirring frequency to 20 Hz and the stirring time to 15 min. The floc particle sizes D10, D50, D90 are respectively: 30.1 μm, 157.9 μm, and 455.2 μm; the capillary suction time (CST) is: 551.1 s.
(4) Use cationic PAM as the flocculant for final flocculation with the dosage of 0.25 wt %, and control the stirring frequency to 13.5 Hz and the stirring time to 5 min to form final floc particles. The floc particle sizes D10, D50, and D90 are respectively: 96.2 μm, 291.7 μm, and 642.4 μm; the capillary suction time (CST) is: 65.86 s.
(5) Pressing and dehydration: use a membrane filter press for mechanical dehydration. The size of the filter plate is 80 cm×80 cm, the pressing pressure is 1.0˜1.6 MPa, the pressing time is 90 min; and the moisture content of the finally obtained filter cake is 57.67%.

The embodiments of the present disclosure have been described above. The above description is illustrative, not exhaustive, and is not limited to the disclosed embodiments. Many modifications and variations will be apparent to those skilled in the art without departing from the scope and spirit of the described embodiments.

1. A method for conditioning advanced anaerobic digestion sludge by deep dehydration based on particle size control, wherein the method for conditioning advanced anaerobic digestion sludge by deep dehydration comprising:
(1) uniformly mixing the advanced anaerobic digestion sludge with first cationic organic flocculant to obtain non-hard muddy flocculated particles;
wherein addition amount of the first cationic organic flocculant is 1.5 wt % 0 to 3.0 wt % of dry solid amount of the advanced anaerobic digestion sludge;
(2) uniformly mixing the muddy flocculated particles obtained in step (1) with aggregate;
wherein addition amount of the aggregate is 3 wt % to 10 wt % of the dry solid amount of the advanced anaerobic digestion sludge;
(3) uniformly mixing mixture obtained in step (2) with inorganic agent to improve particle surface hydrophobicity;
wherein addition amount of the inorganic agent is 0.5 wt % to 3.5 wt % of the dry solid amount of the advanced anaerobic digestion sludge;
(4) adjusting a particle size of floc particles obtained in step (3) using second cationic organic flocculant, so that the floc particles meet the following requirements:
D10: 70-150 μm, D50: 200-400 μm, D90: >500 μm;
(5) dehydrating substance obtained in step (4) to reduce moisture content of the sludge to 60% or less.

2. The method for conditioning advanced anaerobic digestion sludge by deep dehydration based on particle size control according to claim 1, wherein the first cationic organic flocculant is at least one of PAM, tannic acid and polydiallyldimethylammonium chloride.

3. The method for conditioning advanced anaerobic digestion sludge by deep dehydration based on particle size control according to claim 1, wherein the second cationic organic flocculant is PAM.

4. The method for conditioning advanced anaerobic digestion sludge by deep dehydration based on particle size control according to claim 1, wherein the first cationic organic flocculant and the second cationic organic flocculant are both PAM.

5. The method for conditioning advanced anaerobic digestion sludge by deep dehydration based on particle size control according to claim 1, wherein in step (2), the aggregate is selected from at least one of sludge carbon, activated carbon, flyash, and highly dry sludge particles.

6. The method for conditioning advanced anaerobic digestion sludge by deep dehydration based on particle size control according to claim 1, wherein in step (2), a particle size of the aggregate is less than or equal to 0.3 mm.

7. The method for conditioning advanced anaerobic digestion sludge by deep dehydration based on particle size control according to claim 1, wherein in step (3), the inorganic agent is selected from at least one of polyaluminum sulfate, polyaluminum chloride, polyferric sulfate, aluminum chloride, aluminum sulfate and ferric chloride.

8. The method for conditioning advanced anaerobic digestion sludge by deep dehydration based on particle size control according to claim 1, wherein in step (4), addition amount of the second cationic organic flocculant is 1.5 wt % o to 3.0 wt % of the dry solid amount of sludge.

9. A floc particle obtained by the method for conditioning advanced anaerobic digestion sludge by deep dehydration based on particle size control according to claim 1.

10. A method for sludge treatment and disposal, the improvement comprising conditioning advanced anaerobic digestion sludge by deep dehydration based on particle size control according to the method of claim 1.
